(19) United States
(12) Patent Application Publication
(10) Pub. No.: US 2018/0304108 A1
(43) Pub. Date: Oct. 25, 2018

(54) NASAL FILTRATION SYSTEM

(71) Applicant: James Robert Curtis, Carrollton, TX (US)

(72) Inventor: James Robert Curtis, Carrollton, TX (US)

(73) Assignee: Arch Holdings, LP, Carrollton, TX (US)

(21) Appl. No.: 15/492,705

(22) Filed: Apr. 20, 2017

(51) Int. Cl. A62B 23/06; A62B 7/10

(52) U.S. Cl. CPC A62B 23/06; A62B 7/10

(57) ABSTRACT

A system for filtering breathing air and an apparatus for accomplishing the same. The invention describes a nasal filtration system that can be inserted into the nasal passages. The filters include cavities through which air is inhaled or exhaled. The filter performs as a mechanical filter to catch and prevent the inhalation of undesirable particulate. Further, the filter comprises a disinfectant agent, such as colloidal silver, which kills germs, bacteria, and viruses to prevent the spreading of disease.

### BACKGROUND OF THE INVENTION

### Technical Field

The present invention relates to a system for filtering and treating air as it is inhaled or exhaled through the nasal passage. Specifically, a system for filtering microbial elements and allergens from the air as it is inhaled through the nasal passage.

### Description of Related Art

Common colds and viruses spread through the air at a rapid pace. Some diseases, such as the H1N1, Avian, Swine, and Equine flus can spread rapidly from person to person. Diseases spread even faster when people are kept in a small space for an extended period of time. For example, on a train or plane, passengers share a relatively tight space in addition to utilizing recycled air. These tight spaces allow passengers to pass germs, diseases, viruses, bacteria, and allergens between themselves through touching, breathing, sneezing, and coughing. Furthermore, the tight confines of public transportation and public places allow germs, diseases, viruses, bacteria, and allergens to flourish and build up through air recirculation. As such when a passenger sneezes or coughs, the germs spread rapidly in the confined space.

As science progresses, people have become more germ conscious and are seeking devices that prevent the spread of diseases. One such device is the common face mask. The face mask covers the nose and mouth and offers a simple filter through which the breathing air must pass. There are several disadvantages to the face mask. First, masks do not always properly seal. As a result when the user inhales, some of the air bypasses the mask altogether. Second, the mask results in a build up of carbon monoxide within the mask that can cause minor issues for the users and in particular those with breathing or respiratory disorders. Third, users who wear glasses often have the glasses “fog-up” due to the condensation caused by exhaling. Finally, the mask is not aesthetically pleasing. Many prefer not to wear the mask because it is not attractive. Moreover, in a group, a person wearing a mask is viewed as contagious or overly concerned with their health. As such, it is desirable to produce a filtration system which is discrete, effective, and which reduces any “fog-up” problems associated with the prior art.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1A-1B are a front perspective view of a nose.

FIG. 2 is a front perspective view of the filtration device in one embodiment.

FIGS. 3A-F are cut-away views of the filtration device.

FIGS. 4A-4C are a top planar view of the various bridge embodiments.

FIG. 5 is a top perspective view of the installed filtration device.

### DETAILED DESCRIPTION

Several embodiments will now be described with reference to the drawings. Unless otherwise noted, like elements will be identified by identical numbers throughout all figures.

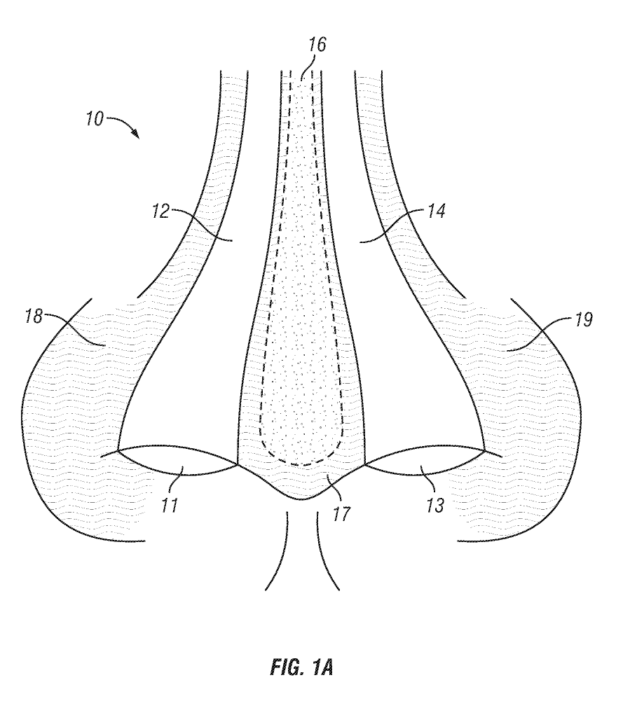

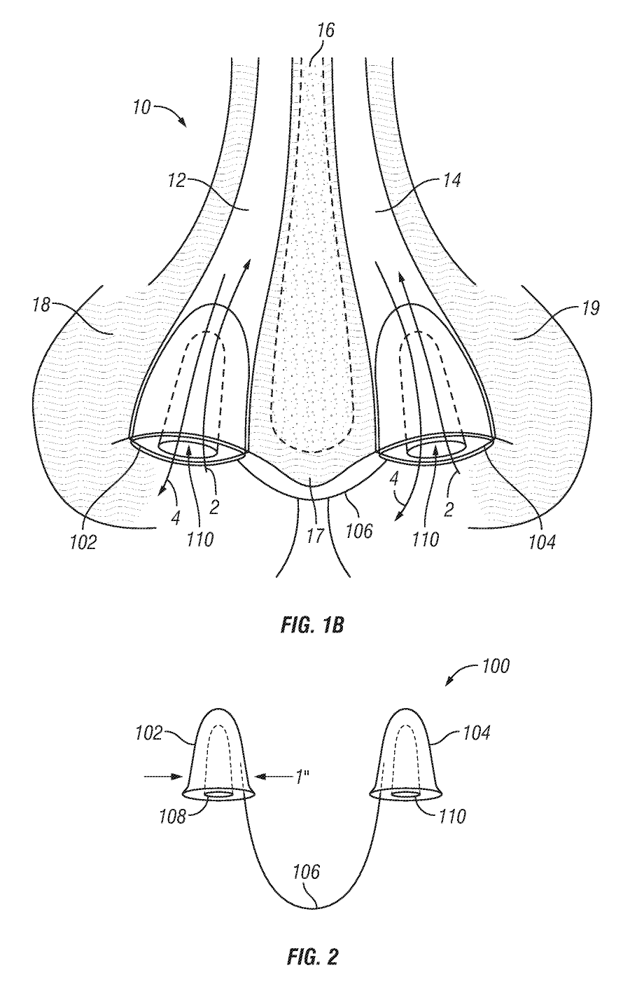

Generally, this invention relates to a filtration device used for filtering breathing air. FIGS. 1A and 1B are a front perspective view of a human nose. FIG. 1A shows a human nose without a filter device, while FIG. 1B illustrates the filtration device within the nasal passages. A human nose comprises a left nasal passage 12 and opening 11, a right nasal passage 14 and opening 13, a septum 16, a columellar region 17, a left alar wall 18, and a right alar wall 19. Air is taken in through inhalation and expelled via exhalation through the nasal passages 12 and 14. The human nose 10 is constantly changing due to growth and gravity. In addition, the septum 16, columellar region 17, left alar wall 18, and right alar wall 19 can also change over time causing changes to not only the outer appearance of the nose but also the internal structure as well. Therefore, rigid, non-compressible, or non-pliable materials are not suitable for use within a nasal filtration system, as they do not allow for the creation of a reliable seal within the nasal passages 12 and 14.

FIG. 1B illustrates one embodiment of compressible and air permeable filters within the nasal passages 12 and 14, via the nasal passage openings 11 and 13. A first filter 102, a second filter 104, and a bridge 106 that connects to the base of each filter is placed within the nasal passages 12 and 14. The filters 102 and 104 are sized to fit and seal against the septum 16, columellar region 17, left alar wall 18, or right alar wall 19. A majority of air passes through the filters 102 and 104 upper regions via the filter cavities 110 due to the seal against the septum 16, columellar region 17, left alar wall 18, or right alar wall 19. As shown, in FIG. 1B during an inhalation 2 air is drawn in through the filters 102 and 104 and is expelled through the filters during an exhalation 4.

FIG. 2 is a front perspective view of the filtration device in one embodiment. The filtration device 100 comprises a first filter 102, a second filter 104, and a bridge 106 that connects to the base of each filter. The size of the filter 102 and 104 can vary to accommodate a multitude of users both young and old, including, but not limited to, small, medium, and large models. In addition, the filters 102 and 104 have a design, size, and shape that allow the filters 102 and 104 to fit snugly within the nasal passages 12 and 14. In one embodiment, the first filter 102 is the same and operates the same as the second filter 104. Thus, while the first filter 102 will be described, the references will be applicable to the second filter 104 as well. Alternatively, the second filter 104 will be described, and the references will be applicable to the first filter 102 as well.

In one embodiment, the filters 102 and 104 are designed with non-rigid or compressible materials. The non-rigid or compressible materials allow the filters 102 and 104 to have, in an uncompressed state, a diameter of approximately ½ to about 1 (one) inch. During compression, the filters 102 and 104 can obtain a compressed diameter that is approximately 30-80% of the uncompressed diameter. In alternative embodiments, the filters 102 and 104 are compressible so that they can obtain a compressed diameter that is less than 40-6⁰% of the uncompressed diameter. Of course, the amount of compressibility is proportional to the density of the filter material and the size of the user's nasal passages or nostrils.

In one embodiment, the filters 102 and 104 are designed with a polyurethane or silicon base or coating that can be impregnated or treated with other materials such as, active charcoal, active carbon, or colloidal silver. The active charcoal or carbon can be from any charcoal or carbon source, from materials such as nutshells, fruit shells, woods, coals, and other flammable products and in a preferred embodiment, is from coconut shell charcoal. Additionally, in certain embodiments the filters can have a shell. This shell can be made of nano-fiber, micro-fiber, polyester, cotton, or a cotton-polyester blend. The shell in combination with other materials used to manufacture the filters 102 and 104 allow them to block particles at least as small as one (1) micron.

In one embodiment, the filters 102 and 104 each include a filter cavity 108 and 110. The cavity is a void space in the filter. However, the cavity may not be required for certain materials, or maybe include passages through the filter material. The size of the cavity 108 and 110 is relative to the size of the filters 102 and 104 and is dependent upon a variety of factors including, but not limited to, what particulate matter, virus, germs, allergens, or diseases the filter would be used for. In one embodiment, the cavity comprises a diameter, or diameter equivalent of about ⅛ of an inch to about ⅜ of an inch. In one embodiment, the filter 102 comprises only a single cavity 108, but in other alternative embodiments, the filter 102 comprises a plurality of cavities 108.

When the filters 102 and 104 are inserted into the nasal passage 12 and 14 through the openings 11 and 13, a seal is created, while air is inhaled first through the cavities 108 and 110. Air then passes through the rest of the filters 102 and 104 and then downstream into the lungs. Additionally, during an exhalation air is expelled through the cavities 108 and 110. As used herein the terms upstream and downstream refer to a location of a process. The term upstream refers to an event or location that occurs prior to an event or location that is downstream.

In one embodiment, the filters 102 and 104 are generally conical in shape, however, other shapes are also possible and in particular a shape such as an oblong or oval base with a conical vertical shape. Likewise, the cavity 108 and 110 is also conically shaped so that the thickness of the filter, as measured from the edge of the cavity 108 and 110 to the periphery of the filter 102 and 104 is substantially constant. In another embodiment, the cavity 108 is elongated. The cavity 108 can comprise a length of about 1/16 of an inch to about¾ of an inch. In one embodiment, the cavity is about 50% to about 90% as long as the filters 102 and 104. An increase of the surface area of the filter cavity 108 allows more air to pass through the surface area during inhalation and exhalation. If the filter cavity 108 were relatively short in comparison to the length of the filters 102 and 104, then the same volume of air would be required to travel through a limited amount of surface area. Thus, the filter cavity 108 would offer a relatively small amount of usable surface area. Usable surface area refers to the amount of surface area through which air can pass during inhalation or exhalation. In contrast, if the filter cavity 108 was relatively long in comparison to the length of the filter, then the amount of usable surface area is increased. Likewise, if a filter 102 and 104 comprises multiple filter cavities 108, then the amount of usable surface area is further increased. Increasing the amount of usable surface area makes it easier to inhale or exhale.

In one embodiment, the size and shape of the cavity 108 maximizes usable surface area. In one embodiment, the cavity 108 has non-linear boundaries that separate the cavity 108 from the filter 102. For example, in one embodiment the cavity 108 comprises jagged edges that offer more surface area than a straight edge. As those skilled in the art will understand, the size of the cavity 108 is often dependent on the material of the filter 102. If the filter 102 comprises dense material, then the cavity 108 could be generally larger to allow for easier inhaling and exhaling.

The cavity 108 can comprise a simple void in the material. Put differently, in one embodiment there is not a membrane layer between the cavity 108 and the rest of the filter 102. In other embodiments, however, the filter 102 comprises a membrane layer on the periphery of the cavity 108. Such a layer offers support to the filter 102 and prevents the filter 102 from caving onto or restricting the cavity 108. The membrane layer can surround the entire external surface of the cavity 108, or it can be placed in certain locations to structurally reinforce the cavity 108. The membrane layer could also be a plurality of layers throughout the filters 102 and 104. For example, one layer could be a mesh, nano-fiber, or microfiber layer that prevents the particles of particular sizes from nano-sized through micron-sized particles. Other layers could include anti-microbial agents, disinfectant agents, or other materials that can be impregnated or treated during manufacturing of the filters 102 and 104. Those skilled in the art will understand when and how to implement the membrane layer.

In some embodiments the filters 102 and 104 comprise an external membrane covering the outer surface of the filter 102 and 104. In one embodiment, the membrane comprises a thickness of about ⅛ of a millimeter to about 2 millimeters. In one embodiment, the membrane comprises a thickness of about ¼ of a millimeter to about 1 millimeter. The external membrane can comprise a material that increases the comfort of the device or improves its hypoallergenic properties. The external membrane may be a dissimilar material than the rest of the filter 102. Thus, the filter 102 may comprise one material while the external membrane comprises a dissimilar material. These dissimilar materials could include but are not limited to, nano-fiber, micro-fiber, synthetic latex, polyurethane, silicon, polyester, cotton, or cotton-polyester blends. In one embodiment, the external membrane increases the structural rigidity of the device. The external membrane may cover the entire outer surface of the filter 102 or may only cover a portion, such as the sides. In one embodiment, the external membrane comprises an air permeable material.

The filter 102 can be made of a variety of materials including cotton, nylon, polyethylene, polypropylene, memory foam, nano-fiber, micro-fiber, synthetic latex, polyester, and hypoallergenic materials such as PCV or polyurethane. Those skilled in the art will be able to determine which material is suitable for a given embodiment. The density of the material should be thin enough to allow the user to easily inhale and exhale through the filter yet thick enough to trap the unwanted particulates. Thus, the filter 102 should comprise air permeable materials. For one embodiment, polyurethane or silicone is utilized to create and/or coat the filter 102.

In one embodiment, the filter 102 comprises a memory foam. A memory foam refers to a breathable material that comprises a pre-set shape. Such foams compress to smaller shapes and then later expanded to the larger, pre-set configuration, namely, the internal shape of the user's nasal passage. The density of the foams can be adjusted to a desired density. The foams can be formed of a variety of materials as discussed above and known in the art.

The memory foam provides a variety of benefits. One benefit is that the density of the foam can be adjusted during manufacturing. Monitoring the density ensures that inhaling and exhaling is not undesirably restricted. Another benefit is that the foam is compressible. Accordingly, a user can slightly compress the filter 102 prior to installation into the nasal passage opening. Thereafter, the filter 102 can expand to fill the nasal passage. In one embodiment, the filter 102 size is such that the filter occupies greater than about 80% of the surface area of the nasal passage opening after expansion of the filter 102. In another embodiment, the filter size is such that it occupies greater than about 90% of the surface area of the nasal passage opening after expansion. This reduces the amount of air that can bypass the filter and reduces the effectiveness of the filter. When the filter 102 expands in place, it becomes secure due to friction and expansion forces. This prevents movement of the filter 102.

The filter 102 acts as a mechanical filter by catching undesirable particulate and preventing them from passing. Undesirable particulates such as pollen, dust, odors, and some bacterial and viruses, depending on the size, can be caught in the filter 102. In one embodiment, the filter 102 further comprises a disinfectant agent. A disinfectant agent as used herein refers to a substance that destroys microorganisms and includes anti-microbial agents. In one embodiment, the disinfectant agent comprises an antibiotic. Those skilled in the art will know which disinfectant agents can be safely employed to attack specific microbes, viruses, etc. The selection of different disinfectant agents allow for the destruction of different microbes.

One filter may comprise a variety of disinfectant agents. These disinfectant agents could include but are not limited to flu vaccines (such as TamiFlu® by Genentech), allergy medicines (such as Flonase® by GSK), and other remedies administered by intranasal delivery. Because the filter is placed in the nasal passage, any disinfectant agent must not be toxic at levels utilized. In one embodiment, the disinfectant agent comprises colloidal silver. In one embodiment, the disinfectant agent comprises MicroBan® made by MicroBan International, Ltd. of Huntersvile, N.C., USA. In one embodiment, an effective dosage of a disinfectant agent is used. As effective dosage is the amount necessary to reach the desired amount of protection. In one embodiment, an effective dosage is a dosage that results in greater than 50% reduction of the virus, bacteria, and/or germs. In another embodiment, an effective dosage is a dosage that results in greater than 99% reduction of the virus, bacterial, and/or germs.

Additionally in FIG. 2, the filters 102 and 104 comprise a base and a top. In one embodiment the filters 102 and 104 comprise a conical shape so that the base is wider than the top. This shape allows the filter to restrict an optimal amount of inhaled air while still fitting within the nasal passage. The filters 102 and 104 can comprise a variety of cross-sectional shapes including circular, oval, and square. Different shapes are suitable for different noses. In addition, because noses continually grow during our lifetime their shape also is constantly changing. The filters 102 and 104 can comprise any suitable length. In one embodiment, the filters 102 and 104 comprise a length so that they can fit snugly within the nasal passage. In one embodiment, the filters 102 and 104 comprise a length from about ¼ of an inch to about 2 inches. In one embodiment, the filters 102 and 104 comprise a length of about ¼ of an inch to about 1 inch.

As seen in FIG. 2, a bridge 106 connects the two filters 102 and 104. The bridge 106 can be soft and bendable or it can be rigid. In one embodiment, the bridge offers either compression or expansion forces upon the filters 102 and 104. For example, in one embodiment the bridge 106 comprises a memory material such as a spring or bent rod. When the filters 102 and 104 are inserted into their respective nasal passage openings 11 and 13, the filters 102 and 104 may have to be pressed together or pressed apart to fit in the nasal passages 12 and 14. If the filters 102 and 104 must be pressed together in an inward direction, the bridge 106 may offer an outward force when the filters are inserted in the nose. Such an outward force maintains the filters 102 and 104 in their installed position. Likewise, if the filters 102 and 104 must be pulled apart in an outward direction before insertion, the bridge 106 may offer an inward force when the filters are inserted. In still other embodiments, the bridge 106 does not offer either an inward or an outward force.

The bridge can be made of any material previously discussed. Further, the bridge may comprise rigid materials such as metal or wood. In one embodiment, the bridge 106 is transparent. The bridge 106 can comprise a variety of shapes. FIG. 2 shows an embodiment wherein the bridge comprises a loop shape. The bridge 106 can be sized to be snugly against the septum or be spaced apart from the septum. The bridge 106 allows insertion and removal of the filtering device. Further, the bridge 106 prevents the filters from being inserted too far within the nasal passage.

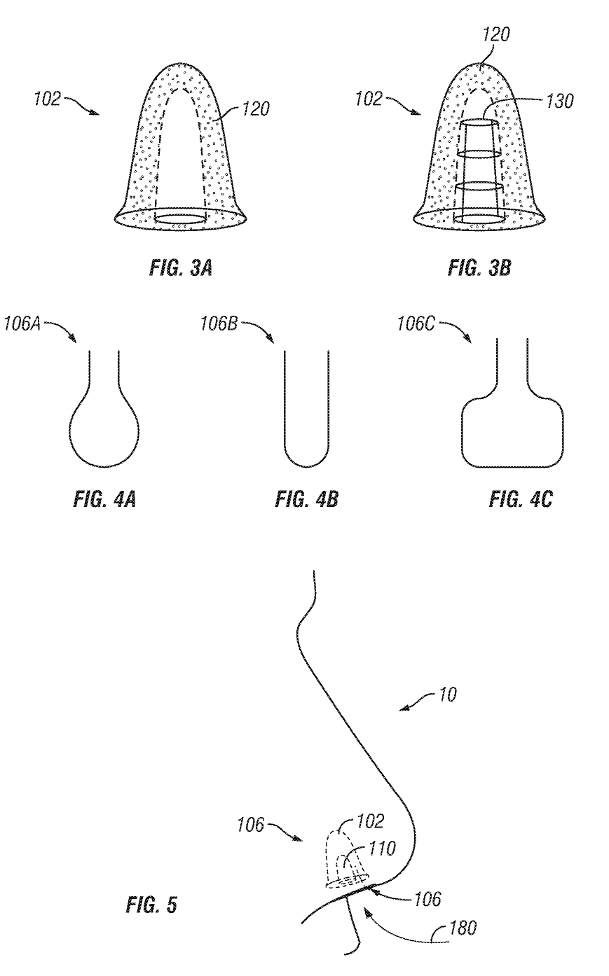

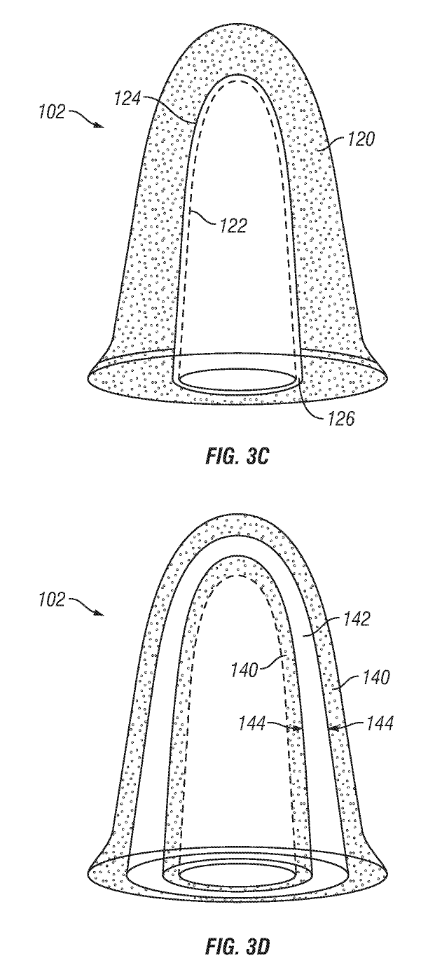

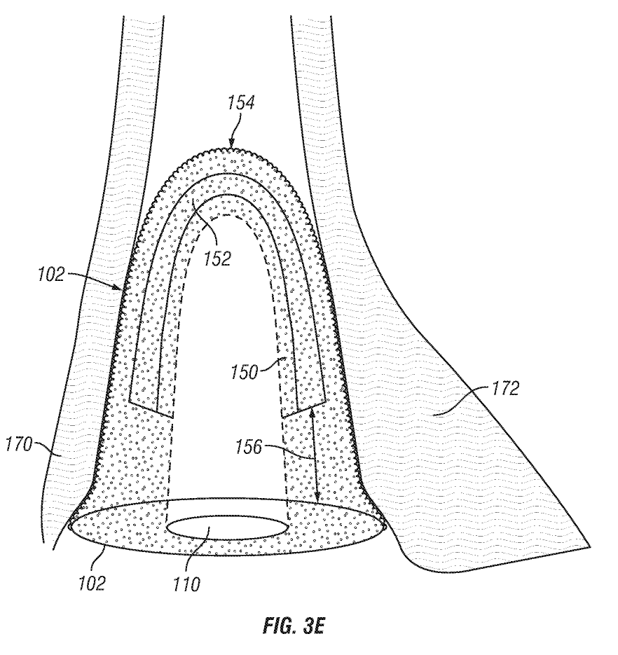

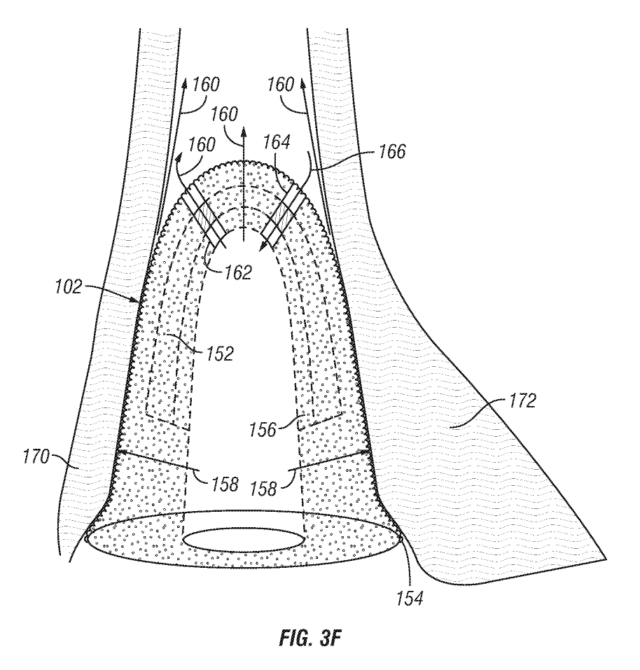

FIGS. 3A-3F illustrate the nasal filter 102 in alternative embodiments of the present invention. With respect to FIG. 3A, the filter 102 can be impregnated or treated during manufacturing with one or more anti-microbial, disinfectant, anti-odor, and antibiotic material or other agents 120. The one or more anti-microbial, disinfectant, anti-odor, and antibiotic material or other agents 120 can be, but are not limited to, being lined within or homogeneously mixed with, the structural material of the filter 102 depending on the manufacturing process utilized. It would be understood by those in the art that different manufacturing processes will require different methods of adding materials or agents to the manufacturing process and those described are used for example purposes.

As discussed, in one embodiment the disinfectant agent comprises colloidal silver. Colloidal silver is known to kill germs, viruses, and bacteria. When employed in the filter 102, the colloidal silver, or other disinfectant agent, kills unwanted germs during an inhale or exhale through the filter. In one embodiment, the filters 102 and 104 kill greater than 50% of germs, viruses, and bacteria that enter the filters 102 and 104. In another embodiment, the filters 102 and 104 kill greater than 99% of the germs, viruses, and bacteria that enter the filter 102 and 104. As the air passes through the filters 102 and 104, they mechanically restrict larger undesired particulates. Likewise, the colloidal silver, or other disinfectant agents, kill or destroy smaller particles before they are fully inhaled or exhaled. As such, the disinfectant agent provides another opportunity to prevent the inhalation of bacteria, viruses, pollen, etc. Thus, the spreading of disease is decreased compared to a simple mechanical filter, such as the common face mask. In one embodiment, an effective dosage of colloidal silver is utilized in the filters 102 and 104. As effective dosage is the amount necessary to reach the desired amount of protection. In one embodiment, an effective dosage is a dosage that results in greater than 50% reduction of the virus, bacteria, and/or germs. In another embodiment, an effective dosage is a dosage that results in greater than 99% reduction of the virus, bacterial, and/or germs.

FIG. 3B depicts an embodiment comprising an interior filter frame 130 that prevents the filter from being completely closed. The interior filter frame 130 can comprise many materials known in the art. In one embodiment, the filter frame 130 adds structural rigidity to the filter. In one embodiment, the filter frame 130 is skeletal to maximize the surface contact between the filter cavity and the disinfectant agent. In alternative embodiments, the filter frame 130 can include or provide support for a web, mesh material, or external membrane between the outer perimeter of the filter cavity and the filter frame 130. In one embodiment, a disinfectant agent is held between the micro layers and weaving created using an activated carbon fabric mesh. The web or mesh material is designed to prevent the passage of particles at least as small as one (1) micron. This allows the anti-odor technology of activated carbon to work with the disinfectant agent to prevent germs, bacteria, viruses, and odors. Activated charcoal and anti-microbial layers allow for 99.99% of fumes, odors, and allergens to be captured within five minutes of contact with the filter surface.

Activated agents such as, but not limited to, activated charcoal or carbon allow for additional filtration, through the absorption of molecules, materials, or chemicals. Activated agents are typically, but not limited to, large or high surface area materials that are highly porous. The surface area and porosity of activated agents can be changed through the addition, manipulation, or modification by other materials or chemicals, such as but not limited to, nitrogen or oxygen, during the activation process. The van der Waals force or dispersion forces such as, but not limited to, a London dispersion force, allows the activated agent to bind the absorbed molecules, materials, or chemicals. Other activated agents can also be used such as those created through a physical or chemical activation. Physical activation is performed at high temperature burning of the material, with other gases or other materials. Chemical activation is performed through chemical impregnation of the charcoal or carbon material that allows the material to be burned and turned into a carbon material at lower temperatures than physical activation. These activated agents can be utilized, but are not limited to, these utilizations, in their natural form, powder or granules, coatings, impregnated into or coating fibers, and also impregnated into or coating other materials.

FIG. 3C shows an embodiment comprising an activated carbon or activated charcoal layer 126, between the outer perimeter of the filter cavity 122 and is separated from the remaining portion of the filter 102 by a membrane or mesh layer 124. In one embodiment, there may be no membrane layer between the active charcoal and active carbon layers, as each is homogenously mixed with the structural material for the filter, and then combined and layered during the final construction processing. The remaining portion of the filter 102 could also be impregnated or treated with other anti-microbial, disinfectant, anti-odor, and antibiotic material or other agents 120.

FIG. 3D illustrates how dual layers can be used to respond to various viruses. For example, during flu seasons the first layer 140 can be treated with hydrophilic coatings to draw moisture away from the outer surface and towards antibiotics, disinfectant agents or other coatings or mixtures. While the second layer 142 is an activated carbon or charcoal and/or a disinfectant agent layer or fiber or mesh that prevent particles as least as small as one (1) micron from entering the nasal passages. In one embodiment, a disinfectant agent or activated carbon or charcoal is held between the micro layers and weaving is created using a micro or nano fiber mesh 144. In other exemplary embodiments the second layer 142 could be a dissimilar materials from the first layer 140. The web or mesh material is designed to prevent the passage of particles at least as small as one (1) micron, and could be made of fibers impregnated or treated with anti-microbial, disinfectant, anti-odor, and antibiotic material or other agents. This allows the anti-odor technology of activated carbon or charcoal to work with the disinfectant agent to provide an anti-germ, bacteria, virus, and odor filtration. Activated charcoal or carbon and anti-microbial layers allow for 99.99% of fumes, odors, and allergens to be captured within five minutes of contact with the filter surface. Each layer can be treated or impregnated with different materials allowing each of the layers to have a different pH environment. Some virus will not be able to withstand a reduction or increase in pH levels; this is also helpful in one embodiment where a hydrophilic plastic coating assists in the rapid absorption of droplets or aerosols that include germs, viruses, and bacteria away from the nasal passages. The hydrophilic plastic coating is particularly advantageous during flu season and for specific flu viruses such as, but not limited to, H1N1, Avian, Swine, and Equine, as the hydrophilic plastic coating assists in drawing aerosol droplets that may contain the virus away from the nasal cavities.

FIG. 3E illustrates one embodiment that includes a first and second layer of agents and materials within the filters. In an exemplary embodiment, the filter 102 has a filter cavity 110 that extends in depth within the relative center of the filter 102 to create a generally equal volume for air to travel through to achieve passage through the filter 102. The filter 102 can have a first layer 150 that can be an activated carbon or charcoal, mesh or filter layer that could include but is not limited to micro, nano and other forms of fibers that can be impregnated or treated with a variety of anti-microbial, disinfectant, anti-odor, and antibiotic material or agents. The second layer 152 can be impregnated or treated with a variety of anti-microbial, disinfectant, anti-odor, and antibiotic material or other agents. The first layer 150 and the second layer 152 could be made of the same, similar or dissimilar materials as the filter 102 as a whole, or the layers 150 and 152 could be the same material as the filter 102 as a whole but impregnated or treated with the different anti-microbial, disinfectant, anti-odor, and antibiotic materials or other agents. A non-linear edge 154 is created along the outer edge of the filter 102 or 104 by the compressible material. This non-linear edge 154 is what creates the seal against the septum, columella, alar, and cartilage within the nasal passage as it forms to the shape and details of the user's nose.

In FIGS. 3E and 3F, the septum, columella and respective cartilage 170, are on the left for a right nasal passage, while the alar and respective cartilage 172, are on the right. Alternatively depending if the nasal passage is the left nasal passage 12 (not shown), or the right nasal passage 14 (shown), a mirror image could be illustrated. In the mirror image for a left nasal passage 12 the septum, columella and respective cartilage 170 would be on the right of the filter 102, and the alar and respective cartilage 172 would be on the left. Depending on the amount of surface area the filter 102 or 104 touches in regards to 170 or 172, air will not pass easily or freely 158 through those portions of the filter 102 or 104, thus, air passage primarily is through the upper portions 160 of the filter 102 or 104. Because of this, the first layer 150 and second layer 152 can begin at a set distance 156 from the base of the filter 102 or 104. The set distance 156 is dictated by the size of the filter 102. This will allow the anti-microbial, disinfectant, anti-odor, and antibiotic material or agents to be more concentrated in the areas most likely to have air passage through them.

Alternative embodiments, of the filters 102 or 104 can include a single or two-way valve 162 or 164. These valves can restrict the inflow and outflow of air through the nasal passages. They can be utilized as exercise tools for users who need to increase their respiratory muscles, such as but not limited to, athletes and those recovering from surgery. In other embodiments, they can be used to add aerosol antibiotics or medicines to the filters 102 or 104 and allow the user to receive metered dosages throughout the wearing period. A partial filter could also be utilized to drive air passage through specific layers that include anti-microbial, disinfectant, anti-odor, and antibiotic material or agents.

FIGS. 4A-4C are a top planar view of other various bridge embodiments. FIG. 4A shows a circular loop. FIG. 4B shows a steep bridge shape. FIG. 4C shows a wide bridge shape. As can be seen, the bridge 106A-106C can be shaped to accommodate septums of varying sizes and shapes. The bridge 106A-106C can comprise a variety of lengths. In one embodiment, the bridge 106A-106C comprises a length of about ⅛ of an inch to about one half inch. In another embodiment, the bridge 106A-106C comprises a length of about ¼ of an inch to about ⅜ of an inch.

FIG. 5 is a side view of the installed filtration device 100. As can be seen the device 100 is inserted 180 so that it is recessed within the nasal passage. In one embodiment, the base of the device is inserted from about 1/16 of an inch to about ¼ of an inch into the nasal passage. To install the device the user simply presses upon either the individual filters 102 and 104 to compress them to a size smaller than the nasal passage opening diameters, inserts the filters 102 and 104, and allows them to expand to fill against the interior walls of the nasal passages. To remove the filters the user grabs the bridge 106 and pulls downward. The filter cavities 108 and 110 provide for a fairly uniform surface area and volume of structural material for air to pass through.

While the invention has been particularly shown and described with reference to a preferred embodiment, it will be understood by those skilled in the art that various changes in form and detail may be made therein without departing from the spirit and scope of the invention.

1. A nasal filtration device comprising:
a first compressible filter of an air permeable material comprising a first base that defines an opening for a first cavity,
a second compressible filter of the air permeable material comprising a second base that defines an opening for a second cavity,
a bridge connecting the first compressible filter to the second compressible filter;
wherein the first compressible filter and the second compressible filter each comprise an outer layer and a first layer, the first layer at least partially bounding the perimeter of the first cavity and the second cavity; and
wherein the first layer includes an activated agent.

2. The filtration device of claim 1, wherein the bridge connects the first base to the second base.

3. The filtration device of claim 1, wherein each of the first base and the second base is formed only from material comprising the outer layer.

4. The filtration device of claim 1 wherein a first layer has a generally conical shape positioned coaxially within the first compressible filter, and wherein the second embedded layer has a generally conical shape positioned coaxially within the first and second compressible filter.

5. The filtration device of claim 1, further comprising a second layer between the outer layer and the first layer, wherein the second layer comprises anti-microbial agents.

6. The filtration device of claim 1 wherein said first compressible filter and the second compressible filter each have a generally conical shape.

7. The filtration device of claim 1 wherein said first compressible filter comprises an external membrane that covers an external surface of the first compressible filter, and wherein the second compressible filter comprises the external membrane that covers an external surface of said second compressible filter.

8. The filtration device of claim 1 wherein said activated agent is comprised of activated charcoal or carbon.

9. The filtration device of claim 1 wherein said first and second cavity of said first and second filters comprise a conical shape.

10. The filtration device of claim 1 wherein said bridge is rigid.

11. The filtration device of claim 1 wherein said bridge is transparent.

12. The filtration device of claim 1 wherein said first and second filter are further comprised of a hydrophilic coating.

13. The filtration device of claim 1 wherein said first compressible filter and said second compressible filter are comprised of synthetic latex, polyurethane, or silicone.

14. The filtration device of claim 1 wherein said first and second filters are sized to fit within a nasal passage.

15. The filtration device of claim 1 wherein said first and second cavity of said first and second filters comprise non-linear edges.

16. The filtration device of claim 1 wherein said first and second filters further comprise a filter mesh.

17. The filtration device of claim 16 wherein the filter mesh blocks particles at least as small as one (1) micron.

18. (canceled)

19. (canceled)

20. The filtration device of claim 1 wherein said first and second filters are further comprised of a shell layer comprising polyester, cotton, or a cotton-polyester blend.

21.-23. (canceled)

24. The filtration device of claim 1, wherein the first layer of the first compressible filter and the second compressible filter only partially bounds the perimeter of the first cavity and the second cavity, wherein the perimeter of the first cavity and the second cavity is bounded by the first layer and material forming the outer layer.

25. The filtration device of claim 1, wherein the first layer of the first compressible filter and the second compressible filter completely bounds the perimeter of the first cavity and the second cavity.

26. The filtration device of claim 25, further comprising:
a second layer between the outer layer and the first layer, wherein the second layer is coextensive and coaxial with the outer layer and the first layer.

27. The filtration device of claim 26, wherein the first layer includes a hydrophilic coating.

28. The filtration device of claim 26, wherein the second layer comprises an anti-microbial agent.
